(19) United States
(12) Patent Application Publication
(10) Pub. No.: US 2014/0334192 A1
(43) Pub. Date: Nov. 13, 2014

(54) PIEZOELECTRIC POWER CONVERTER WITH BI-DIRECTIONAL POWER TRANSFER

(71) Applicant: Noliac A/S, Kvistgaard (DK)

(72) Inventors: Kaspar Sinding Meyer, Copenhagen N (DK); Martin Schøler Rødgaard, Copenhagen N (DK); Michael Andreas Esbern Andersen, Helsinge (DK); Thomas Andersen, Valby (DK)

(73) Assignee: Noliac A/S, Kvistgaard (DK)

(21) Appl. No.: 14/361,037

(22) PCT Filed: Dec. 6, 2012
(86) PCT No.: PCT/EP2012/074614

§ 371 Date: May 28, 2014

Related U.S. Application Data
(60) Provisional application No. 61/567,924, filed on Dec. 7, 2011.

(30) Foreign Application Priority Data
Dec. 7, 2011 (EP) 11192356.1

(51) Int. Cl. H02M 3/335

(52) U.S. Cl. CPC H02M 3/33584
USPC 363/21.01

(57) ABSTRACT

The present invention relates to a bi-directional piezoelectric power converter comprising a piezoelectric transformer. The piezoelectric transformer comprises an input electrode electrically coupled to a primary section of the piezoelectric transformer and an output electrode electrically coupled to an output section of the piezoelectric transformer to provide a transformer output signal. A bi-directional switching circuit is coupled between the output electrode and a DC or AC output voltage of the power converter. Forward and reverse current conducting periods of the bi-directional switching circuit is based on the input drive signal or the transformer output signal such that a forward current is conducted from the output electrode through the bi-directional switching circuit to the DC or AC output voltage in a first state to charge the DC or AC output voltage. In a second state, a reverse current is conducted through the bi-directional switching circuit from the DC or AC output voltage to the output electrode to discharge the DC or AC output voltage and return power to the primary section of the piezoelectric transformer.

The present invention relates to a bi-directional piezoelectric power converter comprising a piezoelectric transformer. The piezoelectric transformer comprises an input electrode electrically coupled to a primary section of the piezoelectric transformer and an output electrode electrically coupled to an output section of the piezoelectric transformer to provide a transformer output signal. A bi-directional switching circuit is coupled between the output electrode and a DC or AC output voltage of the power converter. Forward and reverse current conducting periods of the bi-directional switching circuit is based on the input drive signal or the transformer output signal such that a forward current is conducted from the output electrode through the bi-directional switching circuit to the DC or AC output voltage in a first state to charge the DC or AC output voltage. In a second state, a reverse current is conducted through the bi-directional switching circuit from the DC or AC output voltage to the output electrode to discharge the DC or AC output voltage and return power to the primary section of the piezoelectric transformer.

### BACKGROUND OF THE INVENTION

Traditional piezoelectric transformer based power converters are only capable of supplying power in one direction, from an input voltage/power source to a DC or AC output of the power converter. Furthermore, the piezoelectric transformer is normally operated in a narrow frequency band around its fundamental or primary resonance frequency with a matched load coupled to the output of the piezoelectric transformer. This is required to optimize power conversion efficiency of the power converter. The small optimum frequency band of operation and the need for a matched load make output voltage regulation difficult without sacrificing efficiency of the piezoelectric based power converter. Instead of dissipating surplus power in the load coupled to the secondary side of the power converter, the present power converter enables reverse transmission of power back to the input source providing energy conservation.

Likewise in situations where the excitation frequency is substantially fixed, traditional output voltage control techniques based frequency modulation or pulse width modulation of the input drive signal cannot easily be adapted to control a DC or AC output voltage of the converter without causing considerable deterioration of the power conversion efficiency of the power converter.

Another challenge in the design of traditional piezoelectric transformer based power converters is to obtain zero-voltage-switching (ZVS) in an input driver, typically based on a half-bridge or full-bridge MOS transistor circuit, coupled to a primary or input section of the piezoelectric transformer. ZVS operation of piezoelectric transformers has traditionally been achieved by adding an external inductor in series or in parallel with the primary or input section of the piezoelectric transformer. The external inductor ensures that the input of the piezoelectric transformer appears inductive across a certain frequency range and such that an output node of the input driver can be charged/discharged in accordance with the input drive signal without inducing prohibitive power losses. However, the external inductor occupies space, adds costs and conducts and radiates EMI in the power converter. It would therefore be advantageous to provide a piezoelectric transformer based power converters capable of ZVS operation with good power conversion efficiency without the ordinary external inductor. ZVS operation of piezoelectric transformers is supported in accordance with one aspect of the invention by increasing an apparent ZVS factor of piezoelectric transformer of a power converter by conducting reverse current from the DC or AC output voltage to the secondary section of the piezoelectric transformer as described in further detail below. This methodology increases the apparent ZVS factor of a piezoelectric transformer which can be useful to transform a piezoelectric transformer design or construction without inherent ZVS capability to one with ZVS capability. In addition, even piezoelectric transformer designs with inherent ZVS capability, i.e. a ZVS factor above 100%, can benefit from a further increase of apparent ZVS factor because it enlarges or broadens the frequency band supporting ZVS operation.

### SUMMARY OF THE INVENTION

A first aspect of the invention relates to a bi-directional piezoelectric power converter comprising:

a piezoelectric transformer comprising an input electrode electrically coupled to an input or primary section of the piezoelectric transformer and an output electrode electrically coupled to secondary or output section of the piezoelectric transformer to provide a transformer output signal. An input driver of the bi-directional piezoelectric power converter is electrically coupled to the input electrode and arranged to supply an input drive signal with a predetermined excitation frequency to the input electrode. A bi-directional switching circuit is coupled between the output electrode and an output voltage of the converter and a controller is adapted to control first and second states of the bi-directional switching circuit based on the input drive signal or the transformer output signal such that:

in a first state, forward current is conducted from the output electrode to the output voltage through the bi-directional switching circuit during a first period of a cycle time of the transformer output signal to charge the output voltage,

in a second state, reverse current is conducted from the output voltage to the output electrode through the bi-directional switching circuit during a second period of the cycle time of the transformer output signal to discharge the output voltage and return power to the primary section of the piezoelectric transformer.

The presence of the second state wherein reverse current is conducted from the output voltage through the bi-directional switching circuit to the output electrode allows effective output voltage regulation without sacrificing conversion efficiency of the piezoelectric based power converter. This is because power is returned to the primary section of the piezoelectric transformer. The transmission of reverse current during the second period of the cycle time exploits an inherent bi-directional power transfer property or capability of piezoelectric transformers such that power is transferred in opposite direction to the ordinary direction i.e. forward power flow in the power converter. Surplus power at the output voltage can therefore be transmitted back to the input power source such as a DC supply voltage supplying power to the input driver. According to a preferred embodiment of the invention, the controller is in the second state further configured to control the switching circuit such that both forward current and reverse current is conducted during a single cycle of the transformer output signal. In this embodiment the forward current is conducted during the first period of the cycle time and reverse current is conducted during the second period of the same cycle of the transformer output signal. The second period may have a length corresponding to about one-half or less than the cycle time cycle time of the transformer output signal. The skilled person will appreciate that the degree of charge or discharge of the output voltage may be controlled in a step-wise or substantially continuous manner by a corresponding control of the relative length between the first and second periods of the same cycle of the transformer output signal. In this manner, the controller may provide effective output voltage control through adjustment of the length of the second period of the cycle time. Accordingly, by appropriately balancing the length of the first period of the cycle time relative to the second period of the same cycle, the bi-directional piezoelectric power converter may be adapted to transfer net power to the output voltage or to a load coupled thereto, transfer substantially zero power to the output voltage or transfer a negative power to the output voltage. The skilled person will understand that if the controller sets the length of the second period of the cycle time to zero, the bi-directional piezoelectric power converter conveniently transits from the second state to the first state wherein the bi-directional switching circuit conducts solely forward current so as to charge the output voltage during the first periods of the cycle times. This leads to an increasing level of output voltage e.g. the output voltage becomes more positive or more negative depending on the polarity configuration of the bi-directional switching circuit. In general, the controller may be adapted to terminate the second period of the cycle time, i.e. terminating the reverse conduction of current through the switching circuit, synchronously or asynchronously to the input drive signal or the transformer output signal. The controller preferably comprises an adjustable time delay circuit providing an adjustable duration of the second period of the cycle time of the transformer output signal such that the amount of reverse power can be controlled. The controller is preferably configured to derive a synchronous state control signal from the input drive signal and apply the synchronous state control signal through the adjustable time delay circuit to a switch control terminal of a second controllable semiconductor switch and/or a switch control terminal of the first controllable semiconductor switch of the switching circuit to control respective states of the first and second controllable semiconductor switches. In this manner, the switching circuit is responsive to the synchronous state control signal indicating the termination of the second period of the cycle time. The skilled person will understand that the synchronous state control signal may be derived directly or indirectly from the input drive signal. Indirectly if the synchronous state control signal is derived from another signal in the power converter that is synchronous to the input drive signal such as the transformer output signal. In one such embodiment, the synchronous state control signal is derived from a zero-crossing detector embedded in a self-oscillating feedback loop enclosing an input section of the piezoelectric transformer.

According to a preferred embodiment of the invention, the controller is adapted to sense a current through, or a voltage across, an electrical component of the bi-directional switching circuit. The controller initiates the forward current conduction in the first period of the cycle time in response to a sensed current or voltage so as to asynchronously initiate the forward current conduction. This embodiment simplifies the generation of an appropriately timed control signal or signals for the controller to the bi-directional switching circuit because the forward current conduction is automatically started without any need for a synchronous signal to indicate the correct phase of the transformer output signal. The electrical component may comprise a transistor, a diode or a resistor. In one embodiment, the electrical component comprises a series resistor coupled is series with a semiconductor diode coupled between the transformer output voltage and the output voltage. In this embodiment, the controller may be adapted to detect a flow of forward current by monitoring the polarity of a voltage drop across the series resistor since this polarity indicates the direction of current flow from the transformer output electrode to the output voltage. The flow of forward current through the switching circuit automatically starts when the transformer output signal exceeds the output voltage with approximately one diode voltage drop.

The predetermined excitation frequency is preferably selected or adjusted to a frequency which proximate to, or slightly above, a fundamental resonance frequency of the piezoelectric transformer depending on how the input driver is coupled to the input electrode of the primary section of the piezoelectric transformer. If the input driver is coupled to the primary section through a series/parallel inductor, the predetermined excitation frequency is preferably placed in proximity of the fundamental resonance frequency. The series/parallel inductor is adapted to provide so-called zero voltage switching (ZVS operation) of the input driver. If the input driver on the other hand is directly coupled to the input electrode of the piezoelectric transformer, i.e. without any series/parallel inductor, the predetermined excitation frequency is preferably placed within a selected frequency band or range placed slightly above the fundamental resonance frequency where the piezoelectric transformer may exhibit an intrinsic inductive input impedance, i.e. possess a ZVS factor larger than 100% such as larger than 120% according to the below defined definition of the ZVS factor. The inductive input impedance in the selected frequency band or range enables ZVS operation of the input driver even in the first state of the bi-directional switching circuit so as to eliminate switching losses in the input driver. The setting of the predetermined excitation frequency depends on the fundamental resonance frequency of the piezoelectric transformer which may vary widely depending on its mode of operation and its physical dimensions. However, in a number of useful embodiments, the predetermined excitation frequency lies between 40 kHz and 1 MHz such as between 50 kHz and 200 kHz.

The bi-directional switching circuit preferably comprises one or more controllable semiconductor switches adapted to conduct the forward current from the output electrode to the output voltage during the first period of the cycle time. The one or more controllable semiconductor switches likewise conducts reverse current from the output voltage to the output electrode in the second state. The one or more controllable semiconductor switches preferably comprise(s) a semiconductor selected from the group of {MOSFET, IGBT, bipolar transistor, Gate Turn-Off thyristor (GTO)}. According to a preferred embodiment, each of the one or more controllable semiconductor switches preferably comprises a MOS transistor, such as a NMOS transistor, which is capable of bi-directional current flow between its source and drain terminals with a small on-resistance during both forward and reverse current conduction. The on-states and off-states of each of the MOS transistors are controllable by appropriate control of the drive voltage on a gate terminal of the MOS transistor. One embodiment based on the one or more controllable semiconductor switches comprises a first controllable semiconductor switch arranged between the output electrode and the output voltage and a second controllable semiconductor switch arranged between the output electrode and a negative supply voltage. The negatives supply voltage may be ground reference of the power converter. The controller is configured to alternatingly switch the first and second controllable semiconductor switches to respective on-states and off-states in a non-overlapping manner to control the forward and reverse current conduction. In the first state, this embodiment provides half-wave rectification of the transformer output signal by conducting the forward current to the output voltage through the first controllable semiconductor switch when transformer current out of the output electrode is positive. When the transformer current out of the output electrode is negative the second controllable semiconductor switch conducts and circulates current through the secondary side of the piezoelectric transformer. The skilled person will understand that the bi-directional switching circuit may comprise a full-wave rectification circuit such that a third controllable semiconductor switch is arranged between a second output electrode of the secondary side of the piezoelectric transformer and the output voltage and a fourth controllable semiconductor switch arranged between the second output electrode and the negative supply voltage.

According to an embodiment of the bi-directional piezoelectric power converter, the bi-directional switching circuit further comprises a first semiconductor diode coupled across inlet and outlet nodes of the first controllable semiconductor switch, e.g. drain and source terminals of the MOS transistor, to conduct forward current to the output voltage during at least a portion of a first period of the cycle time. A second semi-conductor diode may be coupled across inlet and outlet nodes of the second controllable semiconductor switch, e.g. drain and source terminals of another MOS transistor, to conduct current during at least a portion of the cycle time of the transformer output signal. The first semiconductor diode or the second semiconductor diode may comprise a body/substrate diode integrally formed with the first or the second semi-conductor switch, respectively. This reduces semiconductor substrate area consumption on a semiconductor die or substrate onto which the power converter may be integrated.

The on-set of flow of forward current through the first semiconductor diode is a convenient detection mechanism for the controller to asynchronously determine when the first controllable semiconductor switch must be switched to its on-state. In this manner, the controller may be configured to sense the forward current through, or the forward voltage across, the first semiconductor diode; and switch the first controllable semiconductor switch to its on-state in response to a sensed forward current or voltage so as to actively clamp the first semiconductor diode during the first period of the cycle time. In this manner, the first semiconductor diode conducts forward current to the output voltage during the portion of the first period of the cycle time and the first controllable semiconductor switch conducts the forward current during a major portion of the first period of the cycle time due to its lower impedance/forward voltage drop once activated.

According to another preferred embodiment of the invention, the controller comprises a self-powered driver coupled between the switch control terminal of the first controllable semiconductor switch and the output electrode of the output section. Furthermore, the self-powered driver comprises a timer circuit configured to control the state of the first semiconductor switch in accordance with a timer period setting wherein the timer period setting is based on the cycle time of the transformer output signal. The termination of the second period of the cycle time is therefore controlled by the timer period setting rather than the previously discussed synchronous state control signal. The coupling of the self-powered or autonomous driver allows the driver to float and follow an instantaneous voltage of output electrode of the piezoelectric transformer. Since the instantaneous voltage of output electrode may rise to a level of several hundred volts or even several kilovolts for high-voltage piezoelectric power converters the lacking need for supplying a switch control signal at the same voltage level to the self-powered driver for terminating the second period of the cycle time is a significant advantage. The self-powered driver preferably comprises a local energy storage component supplying power to the self-powered driver and a rectifying element is coupled between the local energy storage component and a power supply voltage of the power converter to energize the local energy storage component. The local energy storage component may comprise a capacitor or a rechargeable battery that is charged or energized during time intervals wherein the instantaneous voltage at output electrode is relatively small such as below a DC supply voltage of the power converter. The DC supply voltage may be a positive DC supply voltage between 10 and 50 volt such as about 24 volt. During time intervals wherein the instantaneous voltage at output electrode has a high magnitude such as above a positive DC supply voltage or below a negative DC supply voltage of the power converter, the local energy storage component is charged and delivers a local supply voltage to the self-powered driver including the timer circuit allowing these to operate as described above. The rectifying element preferably comprises a high-voltage diode having a break-down voltage larger than 200 V, or more preferably larger than 500 V or larger than 1000 V. In the latter embodiment, the high-voltage diode is preferably the only galvanic connection between the self-powered driver and the power supply voltages or rail of the power converter. The high-voltage diode is reverse biased during time intervals where the instantaneous voltage at output electrode has a high magnitude as described above such that the local energy storage component is the exclusive source of power for the self-powered driver during such time intervals. In one embodiment, the self-powered driver is configured to start the timer in response to a change of bias state of the rectifying element. Consequently, when the instantaneous voltage at output electrode exceeds the local supply voltage, the timer automatically initiates the second period of the cycle time and sets this period substantially equal to the timer period setting. The timer period setting is preferably equal to 50% of the cycle time of the transformer output signal, but may be smaller in other embodiments such as smaller than 20% or 10% of the cycle time of the transformer output signal.

Power converters are often required to provide a specified or target AC or DC voltage as the output voltage within certain bounds or limits which generally require voltage regulation at the load. The present piezoelectric power converter is capable of providing output voltage regulation without sacrificing power conversion efficiency by transferring power back to the input energy source during the second period of the cycle time where the output voltage is discharged as previously described. The controller may be configured to control the switching between the first and second states of the bi-directional switching circuit based on a difference between the output voltage and a predetermined AC or DC reference voltage where the latter is the target AC or DC voltage. If the AC or DC reference voltage is larger than the current output voltage of the piezoelectric power converter, the controller may adapt the bi-directional switching circuit to exclusively operate in the first state to increase the output voltage. On the other hand if the current output voltage of the piezoelectric power converter is smaller the AC or DC reference voltage, the controller may adapt the bi-directional switching circuit to operate in the second state to decrease or discharge the output voltage during the second time periods of the cycle time and at the same time return power to the input power source through the primary section of the piezoelectric transformer.

In one embodiment, the predetermined excitation frequency of the input drive signal is set by a self-oscillating feedback loop arranged around the input driver and the piezoelectric transformer. The use of the self-oscillating feedback loop to set the predetermined excitation frequency or excitation frequency has considerable advantages because the excitation frequency automatically tracks changing characteristics of the piezoelectric transformer itself and electronic circuitry of the input driver. These characteristics will typically vary over operation temperature and age of the piezoelectric power converter, but the feedback loop ensures such changes are tracked by the excitation frequency so as to maintain the excitation frequency at an optimum frequency or within an optimum frequency band. The optimum frequency band may be a frequency range wherein the piezoelectric transformer exhibits inductive behaviour with a ZVS factor higher than 100% such that ZVS operation of the input driver can be achieved even in the first state of the bi-directional switching circuit. In one embodiment the self-oscillating feedback loop comprises an adjustable time delay configured to adjust a phase response of the self-oscillating feedback loop whereby the predetermined excitation frequency is adjusted. This is particularly useful in connection with the present bi-directional piezoelectric power converter wherein the impedance characteristics of the piezoelectric transformer changes at and proximate to the fundamental resonance frequency in response to the level of reverse power transmission. When reverse power is transmitted through the power converter, e.g. during the second state of the bi-directional switching circuit, the excitation frequency set by the self-oscillating feedback loop decreases and the ac resonance current in the piezoelectric transformer increases. This effect can be detected by a resonance current control circuit and compensated by an appropriate adjustment of the delay of the adjustable time delay such that an optimal operation point of the self-oscillating feedback loop can be maintained during both forward power transmission and reverse power transmission of the bi-directional piezoelectric power converter.

A second aspect of the invention relates to a piezoelectric power converter comprising:

a piezoelectric transformer comprising an input electrode electrically coupled to an input or primary section of the piezoelectric transformer and an output electrode electrically coupled to secondary or output section of the piezoelectric transformer to provide a transformer output voltage,

an input driver electrically coupled directly to the input electrode and arranged to supply an input drive signal to the input electrode,

a feedback loop operatively coupled between the output electrode of the piezoelectric transformer and the input driver to provide a self-oscillation loop around the input section of the piezoelectric transformer oscillating at an excitation frequency. The electrical characteristics of the feedback loop are preferably configured to set the excitation frequency of the self-oscillation loop within a ZVS operation range of the piezoelectric transformer.

The piezoelectric power converter according to this second aspect of the invention benefits from the above-described advantages of the self-oscillating feedback loop arranged around the input driver and the piezoelectric transformer. The piezoelectric transformer preferably has a zero-voltage switching factor (ZVS factor) larger than 1.0 or 100%, preferably larger than 1.2 or 120%, such as larger than 1.5 or 150%, or larger than 2.0 or 200%;

in which the ZVS factor is determined at a matched load condition as:

$$ZVS = \frac{{k}_{eff \_ S}^{- 2} - 1}{{k}_{eff \_ P}^{- 2} - 1} 0.882 \qquad ( 1 )$$

k_{eff}_{_{—}}_{P}, being a primary side effective electromechanical coupling factor of the piezoelectric transformer,
k_{eff}_{_{—}}_{S}, being a secondary piezoelectric transformer effective electromechanical coupling factor, in which:

$${k}_{eff \_ P} = \sqrt{1 - \frac{{f}_{res \_ p}^{2}}{{f}_{anti \text{-} res \_ p}^{2}}}$$

$${k}_{eff \_ S} = \sqrt{1 - \frac{{f}_{res \_ s}^{2}}{{f}_{anti \text{-} res \_ s}^{2}}}$$

fᵣₑₛ_{_{—}}ₚ=resonance frequency and frequency of a minimum magnitude of an impedance function at the input electrodes of the piezoelectric transformer with shorted output electrodes,

fₐₙₜᵢ₋ᵣₑₛ_{_{—}}ₚ=anti-resonance frequency and frequency of a maximum magnitude of the impedance function at the input electrodes of the piezoelectric transformer with shorted output electrodes,

fᵣₑₛ_{_{—}}ₛ=resonance frequency and frequency of a minimum magnitude of the impedance function at the output electrodes of the piezoelectric transformer with shorted input electrodes,

fₐₙₜᵢ₋ᵣₑₛ_{_{—}}ₛ=anti-resonance frequency and frequency of a maximum magnitude of the impedance function at the output electrodes of the piezoelectric transformer with shorted input electrodes.

A third aspect of the invention relates to a method of increasing an apparent ZVS factor of a piezoelectric transformer of a power converter. The method comprising steps of:

applying an input drive signal with a predetermined excitation frequency to an input electrode of the piezoelectric transformer,

providing a bi-directional switching circuit coupled between a secondary or output section of the piezoelectric transformer and an output voltage of the power converter,

conducting, in a first state, forward current from the output section to the output voltage through the bi-directional switching circuit during a first period of a cycle time of the transformer output signal to charge the output voltage,

conducting, in a second state, reverse current from the output voltage to the output section through the bi-directional switching circuit during a second period of the cycle time of the transformer output signal to discharge the output voltage,

adjusting the apparent ZVS factor of the piezoelectric transformer by adjusting a length of the second period of the cycle time.

As described above, when reverse power is transmitted through the power converter during the second period of the cycle time of the transformer output signal, the ac resonance current in the piezoelectric transformer increases in response thereto such that it appears more inductive as seen from the input driver coupled to the primary side of the piezoelectric transformer. The increase of apparent transformer input inductance is caused by the increasing energy storage capability of the piezoelectric transformer. This increase of apparent inductance of the piezoelectric transformer is highly useful to reduce the overall size and EMI radiation of the piezoelectric power converter. The higher apparent inductance of the piezoelectric transformer itself allows the input driver to be coupled directly to input electrode of the primary section without any of the normally used series or parallel inductors and still maintain zero-voltage switching conditions in the input driver, i.e. ZVS operation. Thereby, the present methodology of increasing the apparent ZVS factor of the piezoelectric transformer, and the corresponding bi-directional piezoelectric power converter, can utilize piezoelectric transformer types without native ZVS capability, i.e. having a ZVS factor below 100%, and still allow ZVS operation of the input driver. The length of the second period of the cycle time may accordingly be adjusted to a value which provides ZVS operation of the input driver during operation of the power converter in the second state of the switching circuit.

A preferred embodiment of the present methodology comprises a further step of:

conducting both forward current and reverse current during a single cycle of the transformer output signal. As previously explained, the net power transferred to the output voltage may be controlled in either a step-wise or in a substantially continuous manner by a corresponding control of the relative length between the first and second periods of the same cycle of the transformer output signal such that energy efficient and accurate output voltage regulation is possible. Since the amount of reversely transmitted power or energy through the piezoelectric transformer can be varied by adjusting the length of the second period of the cycle of the transformer output signal the apparent ZVS factor of the piezoelectric transformer can be efficiently and accurately controlled.

### BRIEF DESCRIPTION OF THE DRAWINGS

Preferred embodiments of the invention will be described in more detail in connection with the appended drawings, in which:

FIG. 1 is a schematic block diagram of a bi-directional piezoelectric power converter in accordance with a first embodiment of the invention,

FIG. 2 is a schematic block diagram of a self-powered high-side driver for a bi-directional piezoelectric power converter,

FIG. 3 is a schematic block diagram of a bi-directional piezoelectric power converter in accordance with a second embodiment of the invention,

FIGS. 4a)-d) depicts measured forward and reverse current waveforms through a bi-directional switching circuit at four different output power settings of the piezoelectric power converter depicted in FIG. 1,

FIG. 4e) shows measured forward and reverse power figures through the bi-directional piezoelectric power converter over a time period where these quantities are adjusted during operation of the power converter,

FIG. 5 is a schematic block diagram of a generic bi-directional switching circuit,

FIG. 6 is a schematic block diagram of a bi-directional switching circuit configured for half-wave rectification with either positive or negative DC output voltage; and

FIG. 7 is a schematic block diagram of a bi-directional switching circuit configured for full-wave rectification with positive DC output voltage.

### DETAILED DESCRIPTION OF PREFERRED EMBODIMENTS

The below appended detailed description of embodiments of the present invention is directed to bi-directional piezoelectric power converters for voltage step-up or voltage multiplication aimed at generating high DC output voltages such as output voltages from several hundred Volts to several thousand Volts. However, the skilled person will understand that the below described embodiments are highly useful for other types of applications such as step-down and low voltage piezoelectric power converters requiring high power conversion efficiency.

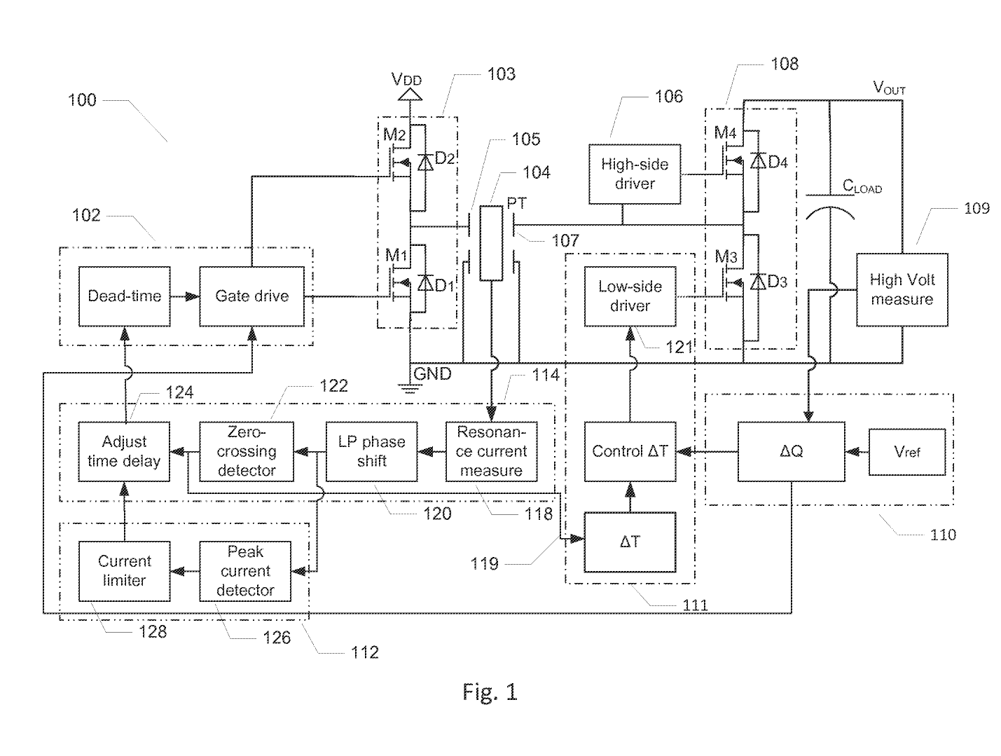

FIG. 1 shows a schematic block diagram of a bi-directional piezoelectric power converter 100 in accordance with a first embodiment of the invention. The bi-directional piezoelectric power converter 100 comprises a piezoelectric transformer, PT, 104. The piezoelectric transformer, PT, 104 has a first input electrode 105 electrically coupled to an input or primary section of the bi-directional piezoelectric power converter 100 and a second input electrode connected to ground, GND. A first output electrode 107 of the piezoelectric transformer 104 is electrically coupled to secondary or output section of the piezoelectric transformer 104 to provide a transformer output signal and a second output electrode is connected to ground, GND like the second input electrode. The bi-directional piezoelectric power converter 100 additionally comprises an input driver 103 electrically coupled directly to the input electrode 105 so as to apply an input drive signal to the input or primary section. A driver control circuit 102 generates appropriately timed gate control signals for NMOS transistors M₂ and M₁ of the input driver 103. The input drive signal has a predetermined excitation frequency determined by parameters of a self-oscillating feedback loop arranged around or enclosing the input driver 103 and the piezoelectric transformer 104. The self-oscillating feedback loop comprises a feedback leg 114 coupling a resonance oscillation signal, having a frequency equal to the predetermined excitation frequency, detected in the piezoelectric transformer structure back to the driver control circuit 102. The self-oscillating feedback loop comprises a resonance current control circuit 112 comprising a peak current detector 126 coupled to a current limiter 128. The resonance current control circuit 112 is configured to adjust a time delay of the adjustable time delay circuit 124 arranged in the feedback leg 114. An ac resonance current in the piezoelectric transformer 104 is detected by a resonance current detector 118 coupled to either the primary side or secondary side of the piezoelectric transformer 104. A resonance current signal supplied by the detector 118 is transmitted to a low-pass or band-pass filter 120 which provides additional phase shift through the feedback loop and may attenuate or suppress certain harmonics components of the fundamental resonance frequency of the piezoelectric transformer 104. A zero-crossing detector 122 receives a filtered signal from the low-pass or band-pass filter 120 and provides an essentially square wave shaped signal indicating zero-crossings of the filtered signal which has an approximate sine shaped waveform. The square wave signal is transmitted to an adjustable time delay circuit 124 which introduces a variable phase in the self-oscillating feedback loop such that the predetermined excitation frequency can be adjusted. An output signal of the adjustable time delay circuit 124 is coupled to the drive control circuit 102 such as to close the self-oscillating feedback loop around the input driver 103. A resonance current control circuit 112 detects a peak current from the output signal of the low-pass or band-pass filter 120 and adjusts a time delay of the adjustable time delay circuit 124 based thereon. This is useful to compensate for a decrease of the excitation frequency set by the self-oscillating feedback loop under reverse power transmission through the piezoelectric power converter, e.g. in the second state of the bi-directional switching circuit. The ac resonance current in the piezoelectric transformer increases under reverse power transmission and the change is detected by a peak current detector 126 of the resonance current control circuit 112. The effect is compensated by limiting the ac resonance current by the current limiter 128 which makes an appropriate adjustment of the time delay in the adjustable time delay circuit 124 such that an optimal operation point of the self-oscillating feedback loop can be maintained during both forward power transmission and reverse power transmission of the bi-directional piezoelectric power converter 100.

In the present embodiment of the invention where the input driver 103 is coupled directly to the input electrode 105 without any series or parallel inductor, the piezoelectric transformer 104 preferably possess a ZVS factor larger than 100% such as larger than 120%. In this manner ZVS operation of the input driver 103 is enabled both in a first state and a second state of a bi-directional switching circuit 108. The ZVS operation of the input driver 103 improves the power conversion efficiency of the bi-directional piezoelectric power converter 100. The predetermined excitation frequency is preferably selected or set to lie slightly above a fundamental resonance frequency of the piezoelectric transformer 104 within a frequency band or range where the piezoelectric transformer 104 exhibits the above-described ZVS factor larger than 100% and appears possess inductive input impedance. The feedback leg 114 is coupled to the resonance current control circuit 112 that detects and limits the ac current flowing inside the piezoelectric transformer 104 as explained in further detail above. The use of the self-oscillating feedback loop has considerable advantages because, the predetermined excitation frequency automatically tracks changing characteristics of the piezoelectric transformer 104 and electronic circuitry of the input side of the power converter like the drive control circuit 102. These characteristics will typically change across operation temperature and age but the self-oscillating feedback loop ensures changes are tracked by the excitation frequency because a slope of the phase response of the piezoelectric transformer 104 is typically much steeper than a slope of a phase response of the low-pass or band-pass filter 120. In this manner, the predetermined excitation frequency will largely be sensitive to changes only of electrical characteristics of the piezoelectric transformer 104 such that the self-oscillating feedback loop automatically maintains the predetermined excitation frequency at an optimum frequency or within an optimum frequency band such as in the ZVS operation range or frequency band of the piezoelectric transformer 104.

At the secondary side of the PT 104, a bi-directional switching circuit 108 is electrically coupled between a transformer output signal generated at the output electrode 107 of the PT 104 and a positive DC output voltage V_{OUT} applied across a load capacitor C_{LOAD} of the power converter 100. The load may of course comprise a resistive and/or inductive component in addition to the depicted load capacitance C_{LOAD}. A controller or control circuit is adapted to control forward current conduction from the output electrode 107 to V_{OUT} through the bi-directional switching circuit 108 during a first period of the cycle time of the transformer output signal. The positive DC output voltage V_{OUT} is accordingly charged during the first period of the cycle time. This transformer output signal, oscillating at the excitation frequency of the input signal, is applied to a midpoint node between series coupled NMOS transistors M₄ and M₃ of the bi-directional switching circuit 108. The output section of the PT 104, oscillating at the excitation frequency, behaves largely as a current source injecting AC current into the midpoint node between series coupled M₄ and M₃ to generate the transformer output signal or voltage. Furthermore, the controller is adapted to control a second period of the cycle time of the transformer output signal wherein reverse current is conducted through the bi-directional switching circuit 108 to the output electrode 107 of the PT such that V_{OUT} is discharged during the second period of the cycle time. During the second period of the cycle time power is returned to the primary section of the piezoelectric transformer through the output electrode 107 of the PT.

The skilled person will appreciate that M₃ and M₄ function as respective controllable semiconductor switches each exhibiting low resistance between an inlet and an outlet node (i.e. drain and source terminals) in the on-state or conducting state and very large resistance in the off-state or non-conducting state. The on-resistance of each of M₃ and M₄ in its on-state may vary considerably according to requirements of a particular application, in particular the voltage level at the DC output voltage V_{OUT} or load impedance. In the present high-voltage embodiment of the invention, each of the M₃ and M₄ is preferably selected such that its on-resistance lies between 50 and 1000 ohm such as between 250 and 500 ohm. The positive DC supply voltage V_{DD} may vary widely in accordance with the requirements of a particular application. In the present embodiment of the invention, the positive DC supply voltage V_{DD} is preferably selected to a voltage between 20 and 40 volt such as about 24 volt.

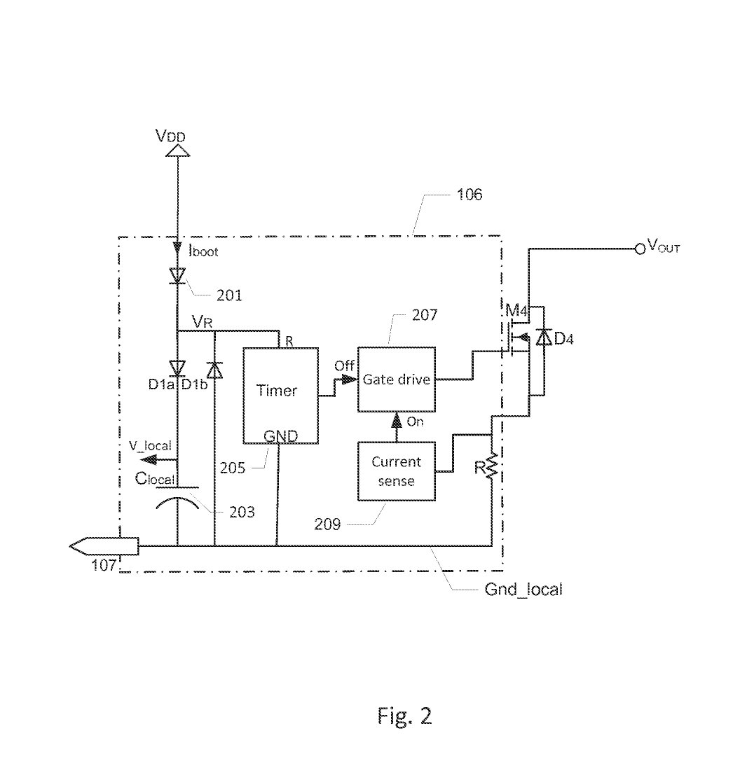

The bi-directional switching circuit 108 comprises a high-side semiconductor diode D₄ arranged or coupled across drain and source terminals of M₄ so as to conduct the forward current to the DC output voltage V_{OUT} in a first state of the bi-directional switching circuit 108. A low-side semiconductor diode D₃ is in a similar manner coupled across drain and source terminals of M₃ so as to conduct the reverse current through the output electrode 107 and output section of the PT 104 during at least a portion of the first state. In the first state, the forward current is conducted from the output electrode 107 of the PT 104 through the bi-directional switching circuit 108 to the DC output voltage V_{OUT} during a first period of a cycle time of the transformer output signal to charge the output voltage. This is accomplished by switching the high-side NMOS transistor M₄ to its on-state or conducting state by a self-powered high-side driver 106 which forms part of the controller. The self-powered high-side driver 106 or self-powered driver 106 is coupled between the control or gate terminal of M₄ and the output electrode 107 which supplies the transformer output signal. The timing of the state switching of M₄ is determined by the detection of forward current in D₄ by a current sensor (not shown) contained in the self-powered driver 106. This current sensor is preferably arranged in series with the high-side semiconductor diode D₄. In response to detection of forward current in D₄ the self-powered driver 106 switches M₄ to its on-state which effectively clamps D₄ such that a majority of the forward current flowing through the parallel connection of M₄ and D₄ to the DC output voltage V_{OUT} in reality flows through M₄. On the other hand, during a negative half-cycle of the transformer output signal in the first state of the bi-directional switching circuit 108, D₄ is reverse biased and M₄ switched to its off-state at expiry of a timer period setting of the timer circuit 205 (refer to FIG. 2) as explained below in additional detail. However, current is now conducted from the negative supply rail, i.e. GND in the present embodiment, to the output electrode 107 of the PT 104 through the parallel connection of M₃ and D₃. Initially, D₃ will start to conduct forward current once it becomes forward biased by the negative transformer output voltage. M₃ is on the other hand, switched to its on-state or conducting state by a low-side driver 121 which forms part of the controller. The low-side driver 121 is coupled to the gate terminal of M₃ and configured to switch M₃ from its off-state to its on-state and vice versa. However, while the timing of the state switching of M₃ from its off-state to the on-state is determined in a manner similar to M₄, the opposite state switching of M₃ is carried out synchronously to input drive signal as explained below. M₃ is switched from the off-state to the on-state by a detection of forward current in D₃ by a current sensor (not shown) contained in the low-side driver 121. This current sensor is arranged in series with the low-side semiconductor diode D₃. At the detection of forward current in D₃ the low-side driver 121 switches M₃ to its on-state which effectively clamps D₃ such that a majority of the forward current flowing through the parallel connection of M₃ and D₃ in reality flows through M₃.

Consequently, in the first state the bi-directional switching circuit 108 functions as a half-wave rectifier or voltage doubler of the transformer output signal such that forward current is conducted from the output electrode 107 of the PT 104 through the high-side NMOS transistor M₄ and semiconductor diode D₄ to the DC output voltage V_{OUT} to charge V_{OUT}. In the negative half-periods of the transformer output signal, current is circulated around the secondary section of the PT 104 without charging the DC output voltage in the current embodiment which uses the half-wave rectification provided by the present bi-directional switching circuit 108. In comparison to a traditional diode-based half-wave rectifier, the bi-directional switching circuit 108 additionally comprises the NMOS transistors M₄ and M₃ of the bi-directional switching circuit 108 arranged for clamping of the high and low-side semiconductor diodes D₄ and D₃. During a second state and during a third state of the bi-directional switching circuit 108, the NMOS transistors M₃ and M₄ are controlled by the controller such that a flow of reverse power is enabled. The reverse current is conducted through the bi-directional switching circuit 108 from the DC output voltage V_{OUT} to the output electrode 107 of the PT 104 during a second period of the cycle time of the transformer output signal so as to discharge V_{OUT}. Due to the inherent bi-directional transfer property of the PT 104 power applied to the secondary section through the output electrode 107 is transferred to the input section of the PT 104 in effect transferring power in opposite direction to the normal flow of power of the power converter 100.

In connection with the reverse current conduction during the second period of the cycle time, state switching of M₃ is controlled by the low-side driver 121 coupled to the gate terminal of M₃. The low-side driver 121 is responsive to a synchronous state control signal derived from the input drive signal supplied by an adjustable time delay circuit, control ΔT, of a phase controller 111. The phase controller comprises the adjustable time delay circuit, control ΔT, and a fixed time delay, ΔT circuit. The phase controller 111 receives the previously mentioned zero-crossing detector output signal 119 which switches states synchronously to the input drive signal and the transformer output signal because this signal is generated inside the self-oscillating feedback loop. Since the input drive signal and the transformer output signal oscillate synchronously to each other, the time delay imposed by the phase controller 111 to the zero-crossing detector output signal 119 sets a length or duration of the second period of the cycle time of the transformer output signal. M₃ is allowed to continue conducting current for the duration of the second period of the cycle time until the state transition of the synchronous state control signal turns off M₃ of the low-side driver 121. While the corresponding state switching of the high-side NMOS transistor M₄ from its on-state to its off-state in one embodiment is controlled by the synchronous state control signal albeit phase shifted about 180 degrees, the present embodiment of the invention uses a different turn-off mechanism provided by the self-powered high-side driver 106. The self-powering of the high-side driver 106 is configured to terminate a reverse current conducting period of M₄ based on an internally generated state control signal supplied by an internal timer rather than the above-described synchronous state control signal supplied by the adjustable time delay circuit, control ΔT. The self-powered property of the high-side driver 106 is highly advantageous for high-voltage output PT based power converters where the DC output voltage may be above 1 kV. The self-powering property of the high-side driver 106 circumvents the need for raising the zero-crossing detector output signal 119 to a very high voltage level, i.e. matching the level of the DC output voltage, before being supplied to the high-side driver 106 to appropriately control the gate terminal of M₄. The skilled person will recognize that the gate terminal of M₄ must be raised to a level above the level of the DC output voltage signal to switch M₄ to its on-state. The self-powered high-side driver 106 is electrically coupled between the gate terminal of M₄ and the output electrode 107 carrying the transformer output voltage as explained in further detail below in connection with FIG. 2.

During operation, the bi-directional piezoelectric power converter 100 comprises two distinct mechanisms for adjusting the level of the DC output voltage V_{OUT}. A first mechanism uses a DC output voltage detection or monitoring circuit 109 which supplies a signal to the output voltage control circuit 110 of the controller indicating the instantaneous level of the DC output voltage. A charge control circuit ΔQ compares the instantaneous level of the DC output voltage with a reference voltage which for example represents a desired or target DC output voltage of the power converter. The charge control circuit determines whether the current DC output voltage is to be increased or decreased based on this comparison and adjusts at least one of: {a modulation of a pulse width modulated input drive signal, a carrier frequency of the pulse width modulated input drive signal, a burst frequency of a burst modulated input drive signal} in appropriate direction to obtain the desired adjustment of the DC output voltage. A second mechanism for adjusting the level of the DC output voltage V_{OUT} also uses the level signal from the DC output voltage detection circuit 109. In this instance the output voltage control circuit 110 adjusts the duration of the second period of the cycle time of the transformer output signal where M₃ conducts reverse current through the adjustable time delay circuit, control ΔT, of the phase controller 111. The corresponding adjustment of the second period of the cycle time as regards M₄ is preferably made by delaying the triggering time or point of a timer circuit included in the self-contained high-side driver 106 as explained below in connection with FIG. 2. The delay of the triggering time of the timer circuit may be controlled dynamically during operation of the bi-directional power converter 100 by the controller by adjusting a delay of an adjustable time delay circuit, control ΔT, to reach a desired or target duration of the second period of the cycle time of the transformer output signal. The adjustable time delay circuit, control ΔT, allows the controller to adjust the duration of the second period of the cycle time of the transformer output signal wherein reverse current is conducted by the bi-directional switching circuit through the output electrode 107 back to the primary side of the PT 104. By this adjustment of the duration of the second period of the cycle time, the amount of reverse power can be effectively controlled allowing for the desired adjustment of the level of the DC output voltage V_{OUT} while conserving power.

The skilled person will appreciate that the degree of charge or discharge of the V_{OUT} may be controlled in a step-wise or substantially continuous manner by a corresponding control of the duration of the second period of the cycle time such that the level of V_{OUT} may be continuously increased or reduced as desired. Furthermore, the length of the second period of the cycle time of the high-side NMOS transistor M₄ may be adapted to track the same for M₃ as explained below in connection with the detailed description of the operation of the self-powered high side driver 106. The skilled person will understand that if the duration of the second period of the cycle time is set to zero by the controller, the bi-directional piezoelectric power converter 100 may be adapted to exclusively operate the first state where the switching circuit charges the positive DC output voltage during the first period of cycle times of the transformer output signal. In this state, the NMOS transistors M₃ and M₄ are only conducting during the first period of the cycle time so as to actively clamp the low-side and high-side semiconductor diodes D₃ and D₄, respectively.

FIG. 2 is a schematic circuit diagram of the design of the self-powered high-side driver 106. The self-powered driver 106 comprising the above-mentioned timer circuit 205 or timer 205 coupled to the gate terminal of NMOS transistor M₄ through gate driver 207 so as to control the duration of its on-state, and possibly an off-state, of M₄ in accordance with a timer period defined by a timer period setting. The timer period or timer delay is preferably adjusted to about 50% of the cycle of the transformer output signal as set by the excitation frequency controlled by the self-oscillating feedback loop. The self-powered driver 106 comprises a rectifying element in form of high-voltage diode 201 coupled in series with a pair of anti-parallel diodes D₁ₐ and D_{1b} which are coupled to a local supply capacitor 203 C_{local}. The local supply capacitor 203 is acting as a rechargeable energy storage component which is charged (as indicated by charge current I_{boot}) with energy from the positive DC supply voltage V_{DD} during conduction periods of the high-voltage diode 201. The voltage V_{—local} on the local supply capacitor 203 C_{local} is coupled to voltage supply lines of the circuit blocks of the self-powered high-side driver 106 to supply operating power to these circuits during time periods where the self-powered driver 106 is isolated or decoupled from the residual portion of the power converter as described below. A reset input R of the timer circuit 205 is coupled to a voltage level V_{R} at a circuit node in-between the high-voltage diode 201 and the anti-parallel diodes D₁ₐ and D_{1b}. When the transformer output voltage at the output electrode 107 of the PT is raised above GND because the low-side NMOS transistor M₃ has been switched to its non-conducting state the AC current supplied by the PT through the output electrode 107 raises the voltage at the midpoint node between series coupled NMOS transistors M₄ and M₃ eventually leading to a forward biasing of the semiconductor diode D₄, the voltage level at V_{R} will fall from approximately V_{DD} towards the local zero potential on node 107, Gnd_local. When the voltage level at V_{R} has dropped down to the local zero potential, the high-voltage diode 201 becomes reverse biased. The timer circuit 205 is triggered because V_{R} is conveyed to the Reset input R of the timer circuit 205. The output of the timer circuit 205 switches to its off state after expiry of the timer period, i.e. about one-half of the cycle time of the transformer output signal in the present embodiment. This state transition is then immediately conveyed to the gate input of M₄ by the gate driver 207. In response M₄ is accordingly switched to its off-state. Consequently, the state switching of M₃ from on-state to the off-state determines when the transformer output voltage at the output electrode 107 begins to increase from the ground level triggering the timer circuit 205 and initiating the timer period according to the timer period setting. Because, the state switching of M₃ from its on-state to its off-state is controlled by the above-described synchronous state control signal supplied by the adjustable time delay circuit, control ΔT, the turn-off timing or instant of M₃ indirectly controls or sets the delayed turn-off timing of M₄. Consequently, by adjustment of the time delay provided by the time delay circuit, control ΔT, the controller is able to adjust the length of the second period of the cycle time of the high-side NMOS transistor M₄ where reverse current is conducted. The current sense circuit is adapted to sense a forward current running through the semiconductor diode D₄ by monitoring a voltage drop across a sense resistor R and turn on M₄ through the gate driver 207 in response to a detection of forward current such that M₄ effectively clamps the semiconductor diode D₄ during the first period of the cycle time of the transformer output signal to establish a low-impedance path for the conduction of forward current through the bi-directional switching circuit to V_{OUT} to charge V_{OUT}.

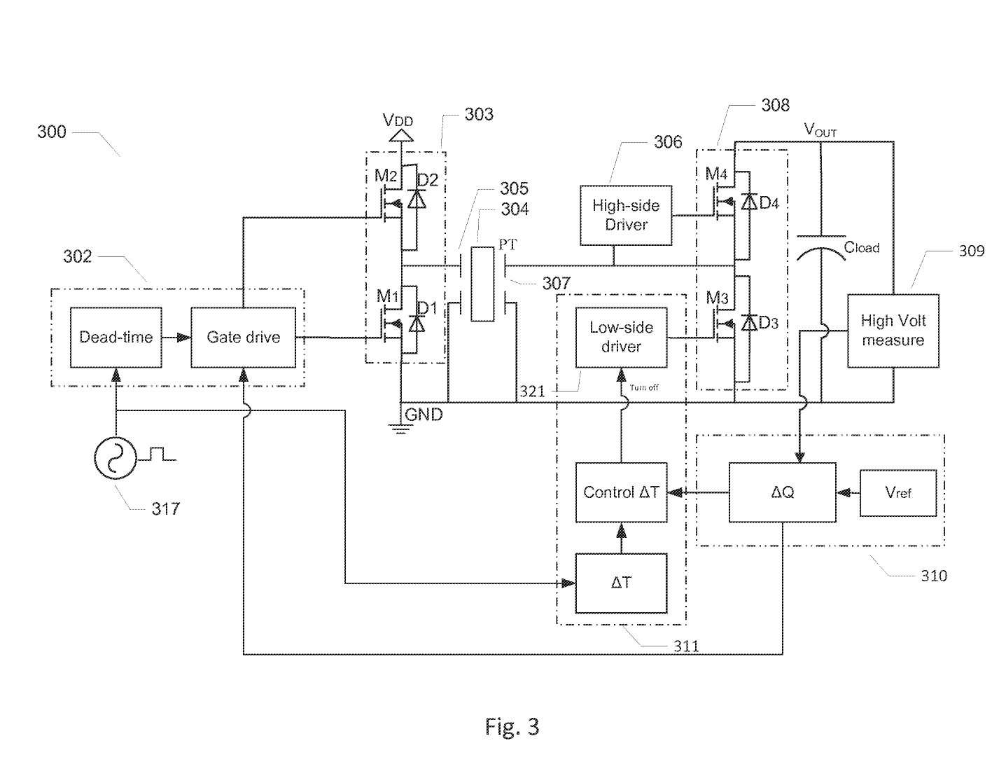

FIG. 3 shows a schematic block diagram of a bi-directional piezoelectric power converter 300 in accordance with a second embodiment of the invention. Corresponding features have been provided with corresponding reference numerals in the first and second embodiments of the bi-directional piezoelectric power converter to ease comparison. Generally, the bi-directional piezoelectric power converter 300 has similar characteristics and features as those explained in connection with the first embodiment, but the way the predetermined excitation frequency at the input driver 302 is set differs. In the first embodiment, the predetermined excitation frequency was set by loop parameters, including parameters of the PT 104, of the self-oscillating feedback loop formed around the piezoelectric transformer. However, in the present embodiment, the predetermined excitation frequency is set by an independent frequency generator or oscillator 317. The predetermined excitation frequency is preferably set to a value within a frequency range where the PT 304 exhibits inductive input impedance. Such inductive input impedance enables ZVS operation of the input driver 303 to improve its power conversion efficiency as explained above.

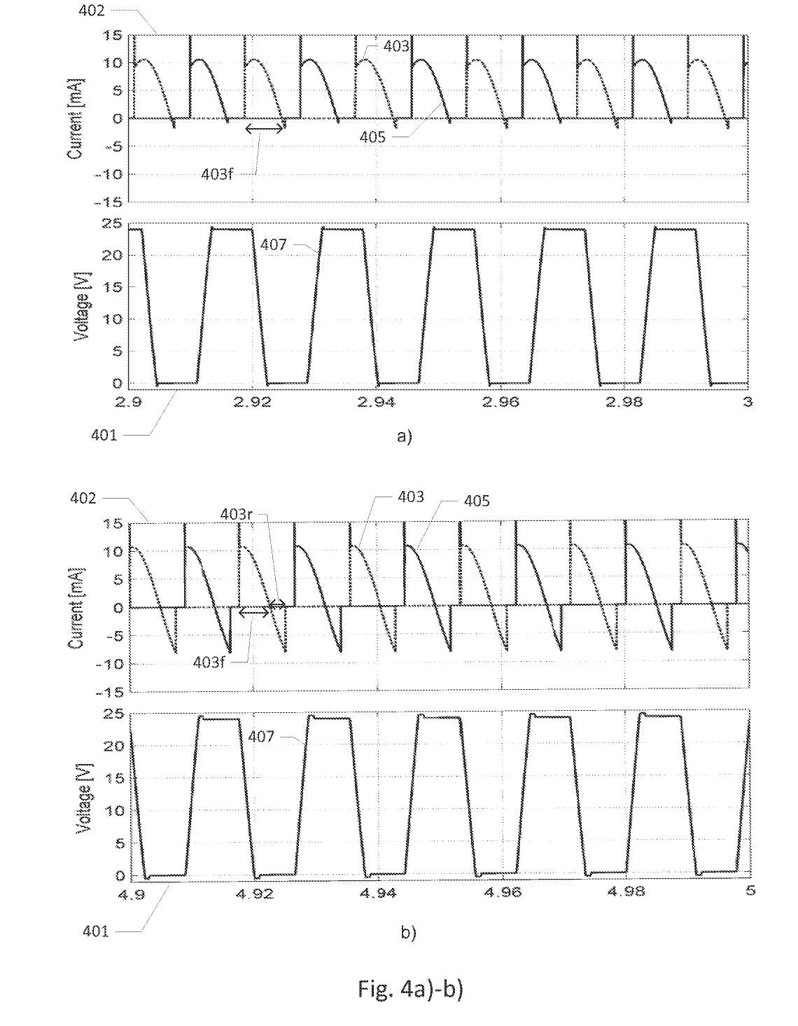

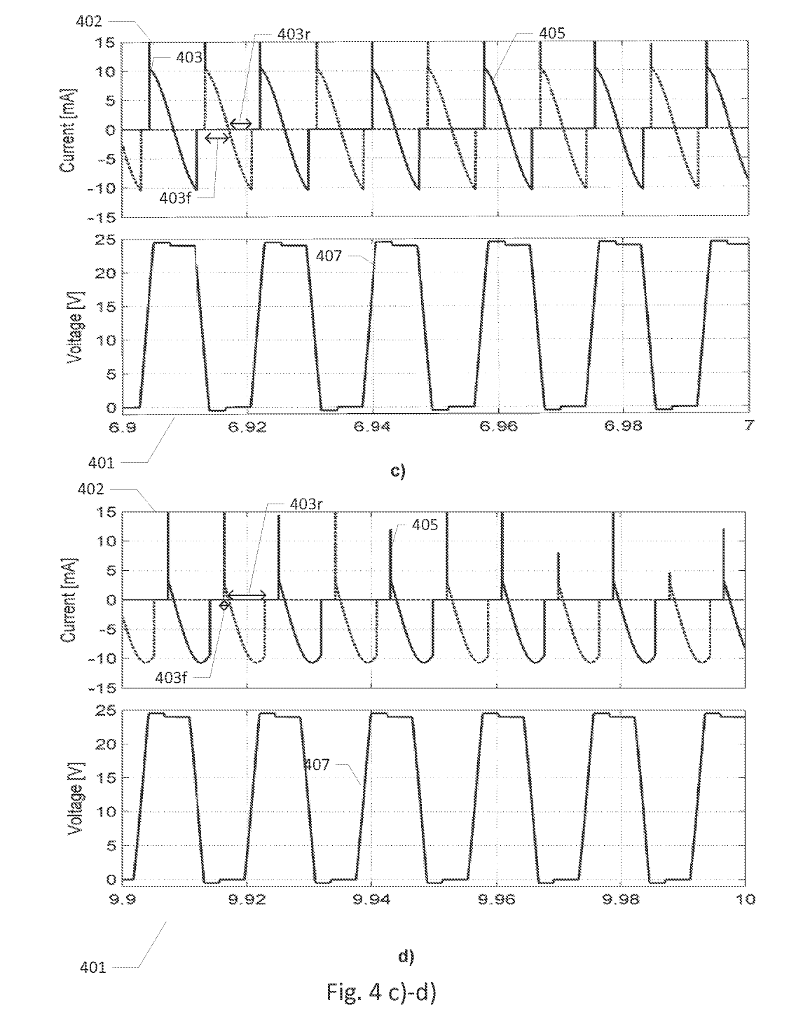

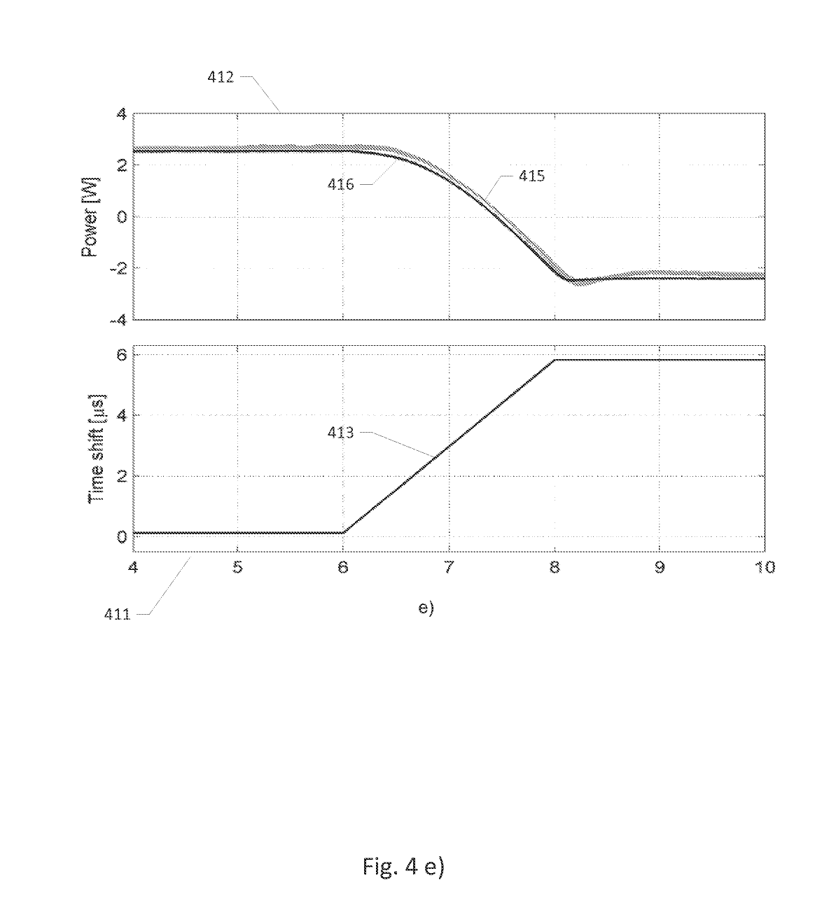

FIGS. 4a)-d) depict measured forward and reverse current waveforms through the bi-directional switching circuit 108 during delivery of a positive, zero and negative net output power to the load capacitor C_{LOAD}. The y-axis of all the upper graphs 402 depicts current in mA and the x-axes time in milliseconds such that the x-axis spans over a time period of about 100 μS. The dotted curve 403 of each of the upper graphs 402 of FIGS. 4a)-d) shows measured current through the parallel connection of M₄ and D₄ to the DC output voltage V_{OUT} (refer to FIG. 1) such that V_{OUT} is charged during positive half-periods of the transformer output signal on the electrode 107. The full line curves 405 of the same graphs 402 of FIGS. 4a)-d) show measured current through the parallel connection of M₃ and D₃ where current is conducted in opposite or negative half-periods of the cycle time of the transformer output signal. In the negative half-periods of the transformer output signal, the current is circulated around the secondary section of the PT 104 without charging the DC output voltage. The lower graphs 401 of FIGS. 4a)-d) show the input drive voltage waveform 407 at the first input electrode 105 which is coupled to the input section of the PT. The y-axis of the lower graphs 401 depicts the input drive voltage in volt. The skilled person will understand that the corresponding transformer output voltage at the electrode 107 may have peak values above several hundred or even several kV due to the voltage gain of the PT 104.

In the depicted operation mode in FIG. 4a), the bi-directional switching circuit operates essentially in its first state where the circuit essentially acts as a traditional half-wave rectifier. The DC output voltage V_{OUT} is charged by the forward current running through the high-side rectifying element, comprising the parallel connection of M₄ and D₄, to the DC output voltage in every positive half-period of the transformer output voltage. The current through the parallel connection of M₄ and D₄ runs forward during the first period 403f of each of the cycle times of the transformer output signal as indicated schematically on the dotted current waveform curve 403. A positive net output power of 2.6 W is delivered to the load capacitor C_{LOAD}.

In FIG. 4b), the bi-directional switching circuit 108 has been switched to its second state and the positive output power to load capacitor C_{LOAD} is reduced from the above 2.6 W to 1.4 W by reverse conduction of power to the input side of the PT. This is evident by inspection of the dotted curve 403 of the upper graph 402 of FIG. 4b) which shows measured current through the high-side rectifying element, comprising the parallel connection of M₄ and D_{4,} to the DC output voltage. The current through the parallel connection of M₄ and D₄ runs forward during a first period 403f of the cycle time of the transformer output signal such that the DC output voltage is charged. However, during a second period 403r of the same cycle of the transformer output signal, the current through the parallel connection of M₄ and D₄ runs in an opposite direction and becomes negative such that the DC output voltage is discharged rather than charged. The second period of the cycle of the transformer output signal, where reverse current is conducted, is introduced or caused by a delayed or phase-shifted turn-off timing of the NMOS transistor M₄ through the adjustable time delay circuit, control ΔT, of the phase controller 111 as previously explained. By comparison of the areas underneath the current waveform 403 during the first and second periods 403f, 403r of the same cycle of the transformer output signal it is apparent that net positive charge or power is transferred to the DC output voltage under the chosen conditions which is consistent with the measured positive output power of 1.4 W.

In FIG. 4c), the bi-directional switching circuit 108 also operates in its second state as was the case in FIG. 4b). However, the output power to the load capacitor C_{LOAD} is reduced from the above 1.4 W to 0.0 W by an increased delay of the turn-off timing of the NMOS transistor M₄ as explained above in connection with FIG. 2. The increased time shift leads to a longer duration of the second period of the transformer output signal where reverse current is conducted through M₄ such the DC output voltage is further discharged compared to the situation in FIG. 4b). This is visible by inspection of the dotted curve 403 of the upper graph 402 of FIG. 4c) which shows measured current through the high-side rectifying element, comprising the parallel connection of M₄ and D₄, to the DC output voltage during consecutive cycle times of the transformer output voltage. The current through the parallel connection of M₄ and D₄ runs forward during a first period 403f of the cycle time of the transformer output signal such that the DC output voltage is charged. However, during a second period 403r of the same cycle of the transformer output signal, the current through the parallel connection of M₄ and D₄ becomes negative as explained above such that the DC output voltage is discharged rather than charged in the second time period. By comparison of the areas underneath the current waveform 403 during the first and second periods 403f, 403r of the same cycle of the transformer output signal it is readily apparent that approximately zero net charge or zero net power is transferred to the DC output voltage during a cycle time of the transformer output voltage under the chosen conditions. This observation is also consistent with the measured output power of 0.0 W.

Finally, in FIG. 4d), the bi-directional switching circuit 108 continues to operate in the second state as was the case in FIGS. 4b) and c). However, the net output power to the load capacitor C_{LOAD} is now negative at −2.4 W rather than positive or zero. This has been achieved by a further increase of the delay of the turn-off timing of the NMOS transistor M₄ as explained above in connection with FIG. 2. The increased time shift leads to a longer duration of the second period of the transformer output signal where reverse current is conducted through M₄ such the DC output voltage is further discharged compared to the situation in FIG. 4c). This is visible by inspection of the dotted curve 403 of the upper graph 402 of FIG. 4d) which shows measured current through the high-side rectifying element, comprising the parallel connection of M₄ and D₄ to the DC output voltage during consecutive cycle times of the transformer output voltage. The first period 403f of the cycle time of the transformer output signal is very small such that only a single short spike of forward current through the parallel connection of M₄ and D₄ is visible making the amount of charge or forward current transferred to the DC output voltage nearly zero during the first period 403f. However, the second period 403r has nearly a duration of an entire half-period of the cycle time or period of the transformer output signal such that a large amount of reverse current is conducted through the parallel connection of M₄ and D₄ leading to a substantial discharge of the DC output voltage. Consequently, by comparison of the areas underneath the current waveform 403 during the first and second periods 403f, 403r of the same cycle of the transformer output signal it is readily apparent that substantial amount of negative net charge or negative net power is transferred to the DC output voltage during a cycle time of the transformer output voltage under the chosen conditions. This observation is also consistent with the measured output power of −2.4 W.

FIG. 4e) shows measured forward and reverse power figures through the bi-directional piezoelectric power converter over a time period of approximately 6 milliseconds where these quantities are dynamically adjusted in opposite direction during operation of the piezoelectric power converter. The upper graph 412 shows corresponding values of measured input power, curve 415, and output power, curve 416, over time. The lower graph 411 shows the delay of the turn-off timing of the NMOS transistor M₄ which is controlled by the turn-off timing of the low-side NMOS transistor M₃ through the adjustable time delay circuit, control ΔT, of the phase controller 111 as previously explained. The y-axis of the lower graph 411 depicts this time delay in μS. As illustrated, the controller of the present piezoelectric power converter enables both full forward transmission of power from the input to the output as illustrated at a time delay value of zero μs. In this operation state, substantially all input power of approximately 2.6 W is transferred to the load capacitor C_{LOAD} When the time delay is gradually increased from about 1 μs to about 6 μs over time depicted along the x-axis from about 6 ms to about 8 ms, the input power gradually becomes less and less positive and finally negative indicating that a continuously increasing amount of power is transmitted in reverse direction from the output voltage and back to the primary section of the piezoelectric transformer. The measured output power curve 416 has a mating shape indicating that a gradually decreasing output power and finally a negative output power is supplied to the load capacitor C_{load}. Hence the load capacitor is discharged by reverse power transmission back to the primary section of the piezoelectric transformer. The skilled person will appreciate the efficient and flexible way the present bi-directional piezoelectric power converter can be adapted for both forward and reverse transmission of power by control of the first and second states of the bi-directional switching circuit. This property enables energy efficient and accurate output voltage regulation.

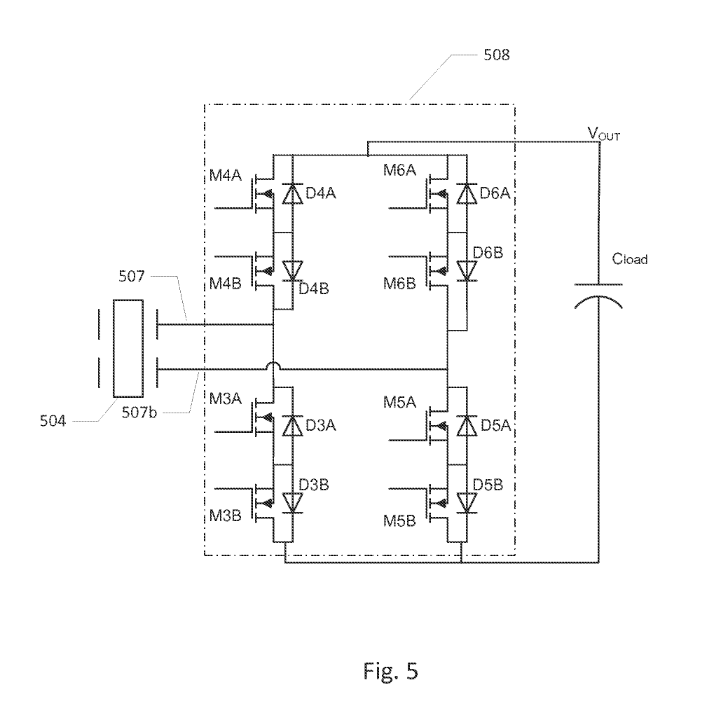

FIG. 5 is a schematic block diagram of a generic and highly versatile bi-directional switching circuit 508 coupled to a PT 504. The bi-directional switching circuit 508 can be programmed to provide a positive or negative output voltage across the load capacitor C_{load} and to provide half-wave or full-wave rectification of the transformer output signal supplied between the positive output electrode 507 and a negative, or opposite phase, output electrode 507b. The different modes of operation can be obtained through appropriate programming or setting of respective control voltages on the gate terminals of the NMOS transistors M4A, M4B, M3A, M3B, M6A, M6B, M5A and M5B. The transformer output signal at the positive output electrode 507 is applied to a midpoint node of a first branch of cascaded NMOS transistors M4A, M4B, M3A and M3B wherein an upper leg or high-side leg comprises M4A and M4B while a lower leg comprises cascaded NMOS transistors M3A and M3B. The oppositely phased transformer output signal at the negative output electrode 507b is applied to a midpoint node of a second branch of cascaded NMOS transistors M6A, M6B, M5A and M5B wherein an upper leg or high-side leg comprises M6A and M6B while a lower leg comprises cascaded NMOS transistors M5A and M5B. The secondary side of the PT 504 acts as a current source through the positive and negative output electrodes 507, 507b, respectively.

With NMOS transistors M4A, M4B and NMOS transistors M5A, M5B in their respective on-states/conducting states, a positive output voltage V_{OUT} is applied to the output electrodes 507, 507b irrespective of the polarity of the current delivered by the secondary side of the PT 504 through the positive and negative output electrodes 507, 507b, respectively. With NMOS transistors M4A, M4B and NMOS transistors M6A, M6B in their respective on-states/conducting states, zero volts is applied to the output electrodes 507,507b irrespective of the polarity of the current delivered by the secondary side of the PT 504 through the positive and negative output electrodes 507, 507b, respectively. With NMOS transistors M3A, M3B and NMOS transistors M6A, M6B in their respective on-states/conducting states, a negative DC output voltage V_{OUT} is applied to the output electrodes 507,507b irrespective of the polarity of the current delivered by the secondary side of the PT 504 through the positive and negative output electrodes 507, 507b, respectively.

In this manner, the bi-directional switching circuit 508 enables a controlled bidirectional flow of power through the PT 504 for output voltages of any polarity. Some of the different modes of operation are described below in further detail.

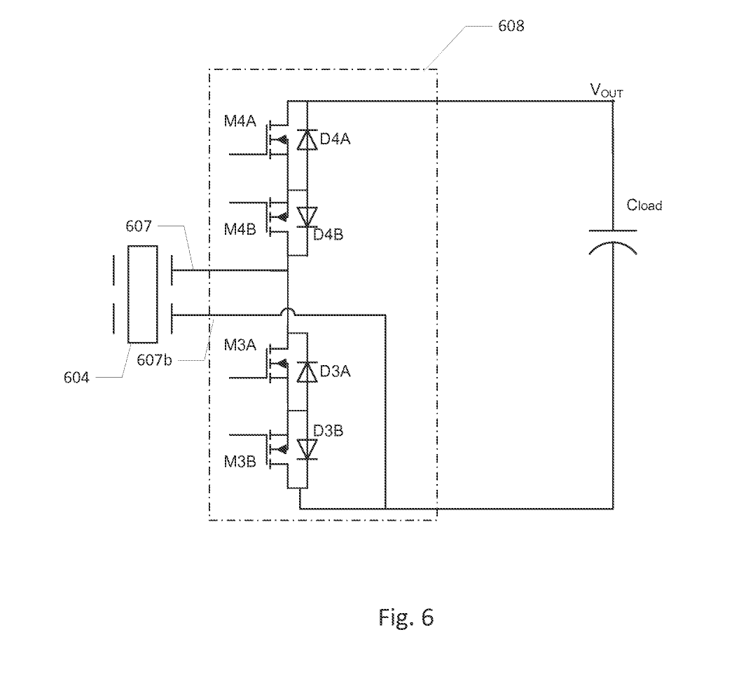

FIG. 6 is a schematic block diagram of a bi-directional switching circuit 608 configured for half-wave rectification of the transformer output signal supplied between the positive and negative output electrode 607 and 607b, respectively. The present bidirectional switching circuit 608 is capable of providing both positive and negative output voltages at V_{OUT} by appropriate programming or adaptation. By constantly holding the NMOS transistors M4B, M3B in their respective on-states or conducting states during operation of the switching circuit 608, M4A and M3A will act as a half-wave rectifier generating a positive voltage at V_{OUT} by adapting the control signals for these NMOS transistors in the manner described above in connection with the first embodiment of the invention. This mode of operation of the bi-directional switching circuit 608 is accordingly similar to the operation of the bi-directional switching circuit 308 described previously under the first embodiment of the invention. The bi-directional switching circuit 608 can however also be programmed to provide a negative output voltage at V_{OUT} by setting the NMOS transistors M4A and M3A constantly to their on-states. In this alternative mode of operation, M4B and M3B will act as a half-wave rectifier generating a negative DC output voltage when appropriate control signals are applied to their respective gate inputs.

The secondary side of the PT 604 acts as a current source through the positive and negative output electrodes 607, 607b, respectively as previously explained. With NMOS transistors M4A, M4B switched to their respective on-states/conducting states, a positive output voltage V_{OUT} is applied to the output electrodes 607 irrespective of the polarity of the current delivered by the secondary side of the PT 604 through the positive output electrode 607. With NMOS transistors M3A, M3B switched to their respective on-states/conducting states, zero volts is applied to the output electrodes 607 irrespective of the polarity of the current delivered by the secondary side of the PT 604 through the positive output electrode 607. In this manner, the bi-directional switching circuit 608 enables a controlled bi-directional flow of power through the PT 604 for positive output voltages at V_{OUT} in a first state and controlled bi-directional flow of power through the PT 604 for negative output voltages at V_{OUT} in a second state.

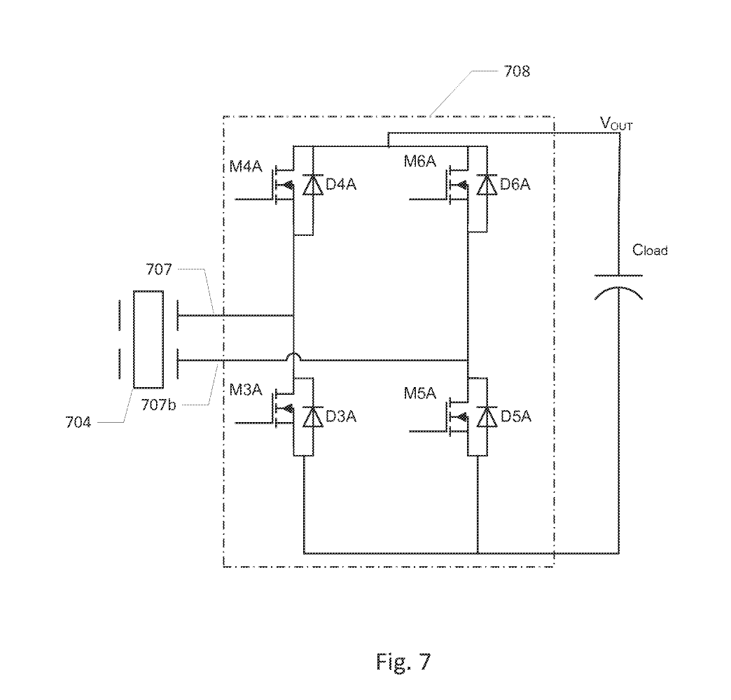

FIG. 7 is a schematic block diagram of a bi-directional switching circuit 708 configured for full-wave rectification of the transformer output signal supplied between the positive and negative output electrode 707 and 707b, respectively. The bi-directional switching circuit 708 is configured to generate a positive output voltage across the load capacitor e.g. a positive DC voltage. The secondary side of the PT 704 acts as a current source through the positive and negative output electrodes 707, 707b, respectively as previously explained. With NMOS transistors M4A, M5A switched to their respective on-states/conducting states, the voltage V_{OUT} is applied to the output electrodes 707, 707b irrespective of the polarity of the current delivered by the secondary side of the PT 704 through the output electrodes 707, 707b. With NMOS transistors M4A, M6A switched to their respective on-states/conducting states, or NMOS transistors M3A, M5A switched to their respective on-states/conducting states, zero volts is applied to the output electrodes 707, 707b irrespective of the polarity of the current delivered by the secondary side of the PT 704 through the output electrodes 707, 707b. With NMOS transistors M3A, M6A switched to their respective on-states/conducting states, minus V_{OUT} (−V_{OUT}) is applied to the output electrodes 707, 707b irrespective of the polarity of the ac current delivered by the secondary side of the PT 704 through the output electrodes 707, 707b.

1. A bi-directional piezoelectric power converter comprising:
a piezoelectric transformer comprising an input electrode electrically coupled to an input or primary section of the piezoelectric transformer and an output electrode electrically coupled to secondary or output section of the piezoelectric transformer to provide a transformer output signal,
an input driver electrically coupled to the input electrode and arranged to supply an input drive signal with a predetermined excitation frequency to the input electrode,
a bi-directional switching circuit coupled between the output electrode and an output voltage of the converter,
a controller adapted to control first and second states of the bi-directional switching circuit based on the input drive signal or the transformer output signal such that:
in a first state, forward current is conducted from the output electrode to the output voltage through the bi-directional switching circuit during a first period of a cycle time of the transformer output signal to charge the output voltage,
in a second state, reverse current is conducted from the output voltage to the output electrode through the bi-directional switching circuit during a second period of the cycle time of the transformer output signal to discharge the output voltage and return power to the primary section of the piezoelectric transformer.

2. A bi-directional piezoelectric power converter according to claim 1, wherein the controller in the second state is further configured to control the switching circuit such that:
both forward current and reverse current is conducted during a single cycle of the transformer output signal.

3. A bi-directional piezoelectric power converter according to claim 1, wherein the controller is adapted to terminate the second period of the cycle time synchronously to the input drive signal or synchronously to the transformer output signal.

4. A bi-directional piezoelectric power converter according to claim 1, wherein the controller is adapted to initiate the first period of the cycle time synchronously to the input drive signal or synchronously to the transformer output signal.

5. A bi-directional piezoelectric power converter according to claim 1, wherein the controller is adapted to:
sense a current in, or a voltage across, an electrical component of the bi-directional switching circuit,
initiate the forward current conduction in the first period of the cycle time in response to the sensed current or voltage so as to asynchronously initiate the forward current conduction.

6. A bi-directional piezoelectric power converter according to claim 1, wherein the bi-directional switching circuit comprises:
a first controllable semiconductor switch arranged between the output electrode and the output voltage,
a second controllable semiconductor switch arranged between the output electrode and a negative supply voltage; wherein the controller is configured to alternatingly switch the first and second controllable semiconductor switches to respective on-states and off-states in a non-overlapping manner to control the forward and reverse current conduction.

7. A bi-directional piezoelectric power converter according to claim 6, wherein the bi-directional switching circuit further comprises:
a first semiconductor diode coupled across inlet and outlet nodes of the first controllable semiconductor switch to conduct forward current to the output volt-age during at least a portion of the first period of the cycle time.

8. A bi-directional piezoelectric power converter according to claim 7, wherein the controller is configured to sense the forward current through, or the forward voltage across, the first semiconductor diode; and
switch the first controllable semiconductor switch to the on-state in response to a sensed forward current or voltage so as to actively clamp the first semiconductor diode during the first period of the cycle time.

9. A bi-directional piezoelectric power converter according to claim 1, wherein the controller comprises an adjustable time delay circuit providing an adjustable duration of the second period of the cycle time of the trans-former output signal.

10. A bi-directional piezoelectric power converter according to claim 9, wherein the controller is configured to derive a synchronous state control signal from the in-put drive signal; and
apply the synchronous state control signal through the adjustable time delay circuit to a switch control terminal of the second controllable semiconductor switch and/or a switch control terminal of the first controllable semiconductor switch to control respective states of the first and second controllable semiconductor switches.

11. A bi-directional piezoelectric power converter according to claim 10, wherein the controller comprises:
a self-powered driver coupled between the switch control terminal of the first controllable semiconductor switch and the output electrode of the output section;
the self-powered driver comprising a timer circuit configured to control the state of the first semiconductor switch in accordance with a timer period setting; said timer period setting being based on the cycle time of the transformer output signal.

12. A bi-directional piezoelectric power converter according to claim 11, wherein the self-powered driver comprises a local energy storage component supplying power to the self-powered driver; and
a rectifying element coupled between the local energy storage component and a power supply voltage of the power converter to energize the local energy storage component.

13. A bi-directional piezoelectric power converter according to claim 11, wherein the self-powered driver is configured to start the timer in response to a change of bias state of the rectifying element.

14. A method of increasing an apparent ZVS factor of a piezoelectric transformer of a power converter, comprising steps of:
applying an input drive signal with a predetermined excitation frequency to an input electrode of the piezoelectric transformer,
providing a bi-directional switching circuit coupled between a secondary or output section of the piezoelectric transformer and an output voltage of the power converter,
conducting, in a first state, forward current from the output section to the output voltage through the bi-directional switching circuit during a first period of a cycle time of the transformer output signal to charge the output voltage,
conducting, in a second state, reverse current from the output voltage to the output section through the bi-directional switching circuit during a second period of the cycle time of the transformer output signal to discharge the output voltage,
adjusting the apparent ZVS factor of the piezoelectric transformer by adjusting a length of the second period of the cycle time.

15. A method of increasing an apparent ZVS factor of a piezoelectric transformer of a power converter, comprising a further step of:
conducting both forward current and reverse current during a single cycle of the transformer output signal.
